(19) United States
(12) Patent Application Publication
(10) Pub. No.: US 2016/0187454 A1
(43) Pub. Date: Jun. 30, 2016

(54) SYSTEM AND METHOD FOR SEPARATING SOUND AND CONDITION MONITORING SYSTEM AND MOBILE PHONE USING THE SAME

(71) Applicant: ABB TECHNOLOGY LTD, Zürich (CH)

(72) Inventors: Maciej Orman, Radziszow (PL); Detief Pape, Nussbaumen (CH)

(73) Assignee: ABB Technology Ltd., Zurich (CH)

(21) Appl. No.: 14/911,409

(22) PCT Filed: Sep. 27, 2013
(86) PCT No.: PCT/EP2013/070283

§ 371 Date: Feb. 10, 2016

(30) Foreign Application Priority Data
Aug. 14, 2013 (CN) 201310353967.3

(51) Int. Cl. G01S 3/802; G01S 3/803

(52) U.S. Cl. CPC G01S 3/8022; G01S 3/803

(57) ABSTRACT

Invention provides a system and method for separating sound from an object of interest from its background and condition monitoring system and mobile phone using the same. The sound separating system includes a sound source localizing part, including at least one microphone and a processing unit, and an object direction reference determination part, determining, as object direction reference, information on directions of the object of interest with respect to the sound source localizing part; wherein the processing unit obtains information on a direction from which sound arrives at the sound source localizing part from the sound source by using microphone signal, and comparing it with the object direction reference so as to filter the sound from the background of the sound source. By having the sound separating system, it can extract the background noise from a specific device respective location and analyse only these signals from the object of interest.

### TECHNICAL FIELD

The invention relates to system and method for separating sound arriving from an object of interest and its background and a condition monitoring system and a mobile phone using the same.

### BACKGROUND ART

Acoustic analysis is a method which today is often used for example in speech recognition however it is rarely ever used in industry application as a condition monitoring technique. The quality of acoustic monitoring is very much dependent on the background noise of the environment, which the machine is operated at. The effect of background noise can be mitigated by sound source localization. Sound source localization might be performed by acoustic camera.

Sound analysis can be an important quality aspect of condition monitoring tool. When faults in machinery and plant installations occur, they can often be detected by a change in there noise emissions. In this way, acoustic camera makes the hearing procedure automated and more objective. Current technologies of acoustic camera can be used to visualize sounds and their sources. Maps of sound sources that look similar to thermo graphic images are created. Noise sources can be localized rapidly and analysed according to various criteria. An acoustic camera consists of some sort of video device, such as a video camera, and a multiple of sound pressure measuring devices, such as microphones, sound pressure is usually measured as Pascal's (Pa). The microphones are normally arranged in a pre-set shape and position with respect to the camera.

The idea of acoustic camera is to do noise/sound source identification, quantification and perform a picture of acoustic environment by array processing of multidimensional acoustic signals received by microphone array and to overlay that acoustic picture to the video picture. It is a device with integrated microphone array and digital video camera, which provides visualization of acoustic environment. Possible applications of acoustic camera as test equipment are nondestructive measurements for noise/sound identification in interior and exterior of vehicles, trains and airplanes, measurement in wind tunnels, etc. Acoustic camera can also be built in complex platform such as underwater unmanned vehicles, robots and robotized platforms etc. When using microphone array consisting of a multiple of microphones, however, it may entail problems regarding the relatively high complexity, a relatively large volume, and a relatively high cost of the acoustic camera.

In some further conventional concepts, a few microphones are moved between measurements by way of drives, for example motors. The motion tracking of the microphones is done via detection of the parameters of the drives, for example the speed of the motor or the initial position of the motor. The motion of the microphones is limited due to the mechanical restriction of the drive, in other words, the microphone cannot move randomly and some route cannot be followed because of the restriction. Moreover, positional accuracy is limited here in many cases by the length of a sampled or “scanned” area. When moving microphones with motors, the problem of the accuracy of the position of the microphones arises. For example, problems may result due to tolerances of the motor or due to vibrations of the construction. Furthermore, the construction of the arrangement for moving microphones with motors without reflections at fixtures is difficult.

Besides, in the noisy environment of industrial plants, where many devices are operating at the same time, the acoustic analysis system, for example the acoustic camera, will take into account the frequencies of all the sound emitted from the object of interest and its background (environment), and the conventional system is unable to automatically separate the sound from the object of interest and its background. Therefore, the influence of the frequency of the sound from the background with that from the object of interest cannot be automatically removed. In particular as regards a condition monitoring system for detecting a health state/failure of an object of interest, for example electrical motor, which uses the acoustic analysis system, it looks for high amplitude noise signals or certain noise frequencies or pattern and locating the sound source of the noise. However, in case the specific failure signal is lower than the background noise and the frequencies or patterns to be looked for are not known, the analysis is not possible.

### BRIEF SUMMARY OF THE INVENTION

It is therefore an objective of the invention to provide a system for separating sound from an object of interest and that from its background, a sound source consists of the object of interest and its background, including: a sound source localizing part, including at least one microphone and a processing unit; and an object direction reference determination part, being adapted for determining, as object direction reference, information on directions of the object of interest with respect to the sound source localizing part; wherein: the processing unit is adapted for obtaining information on a direction from which sound arrives at the sound source localizing part from the sound source by using microphone signal, and comparing it with the object direction reference so as to filter the sound from the background of the sound source. By having the sound separating system, it can extract the background noise from a specific device respective location and analyse only these signals from the object of interest.

According to another aspect of the invention, it provides a condition monitoring system. The condition monitoring system includes the system for separating sound from an object of interest and that from its background, wherein: the processing unit is further adapted for judging a condition of the object of interest based on a frequency of the filtered sound. By having the condition monitoring system, the extracted signals are processed automatically for failure detection.

According to another aspect of the invention, it provides a mobile phone. The mobile phone includes the system for separating sound from an object of interest and that from its background as an extension of its functionality.

According to another aspect of the invention, it provides a method for separating sound from an object of interest and that from its background, a sound source consists of said object of interest and its background, including: determining, as object direction reference, information on directions of said object of interest with respect to a sound source localizing part; obtaining information on a direction from which sound arrives at said sound source localizing part from said sound source by using microphone signal; and comparing said obtained information with said object direction reference so as to filter the sound from said background of said sound source. By having the method, it can extract the background noise from a specific device respective location and analyse only these signals from the object of interest.

According to another aspect of the invention, it provides a method for condition monitoring of an object of interest using the above method, further comprising: judging a condition of said object of interest based on a frequency of said separated sound. By having the condition monitoring method, the extracted signals are processed automatically for failure detection.

### BRIEF DESCRIPTION OF THE DRAWINGS

The subject matter of the invention will be explained in more detail in the following text with reference to preferred exemplary embodiments which are illustrated in the drawings, in which:

FIG. 1 is a block diagram of a system for localizing a sound source according to one embodiment of present invention;

FIG. 2 illustrates a random movement of the movable unit according to one embodiment of present invention;

FIG. 3A is a block diagram of a system for localizing a sound source according to one embodiment of present invention;

FIG. 3B is a block diagram of a system for localizing a sound source according to one embodiment of present invention;

FIG. 3C is a block diagram of a system for localizing a sound source according to one embodiment of present invention;

FIG. 4 shows a schematic illustration of typical movement of the movable unit according to one embodiment of present invention;

FIG. 5 shows a spectrum illustration of Doppler Effect frequency shift of the microphone signal provided by the microphone of the movable unit;

FIG. 6 shows a visualization of 2-dimension source localization according to one embodiment of present invention;

FIG. 7 shows a visualization of 3-dimension source localization according to one embodiment of present invention;

FIG. 8 shows a typical directional sensitivity of a microphone according to one embodiment of present invention;

FIG. 9 shows the determination of a sound source location is according to the embodiment of FIG. 8;

FIG. 10 shows a flowchart of a method for localizing a sound source according to one embodiment of present invention;

FIG. 11 is a block diagram of a system for separating sound from an object of interest and that from its background by using said system for localizing sound source as described above according to FIG. 3C;

FIG. 12 shows the illustration of the direction indicated by the object direction reference;

FIGS. 13A and 13B show the acoustic spectrum before and after the filtration according to an embodiment of present invention;

FIGS. 14A and 14B show pictures taken by the camera and reproduced on the human machine interface before and after marking the contour of the object of interest according to an embodiment of present invention;

FIGS. 15A and 15B present example spectrum of two electrical motor cases; and

FIG. 16 shows flowchart of a method for separating sound from an object of interest and that from its background according to an embodiment of present invention.

The reference symbols used in the drawings, and their meanings, are listed in summary form in the list of reference symbols. In principle, identical parts are provided with the same reference symbols in the figures.

### PREFERRED EMBODIMENTS OF THE INVENTION

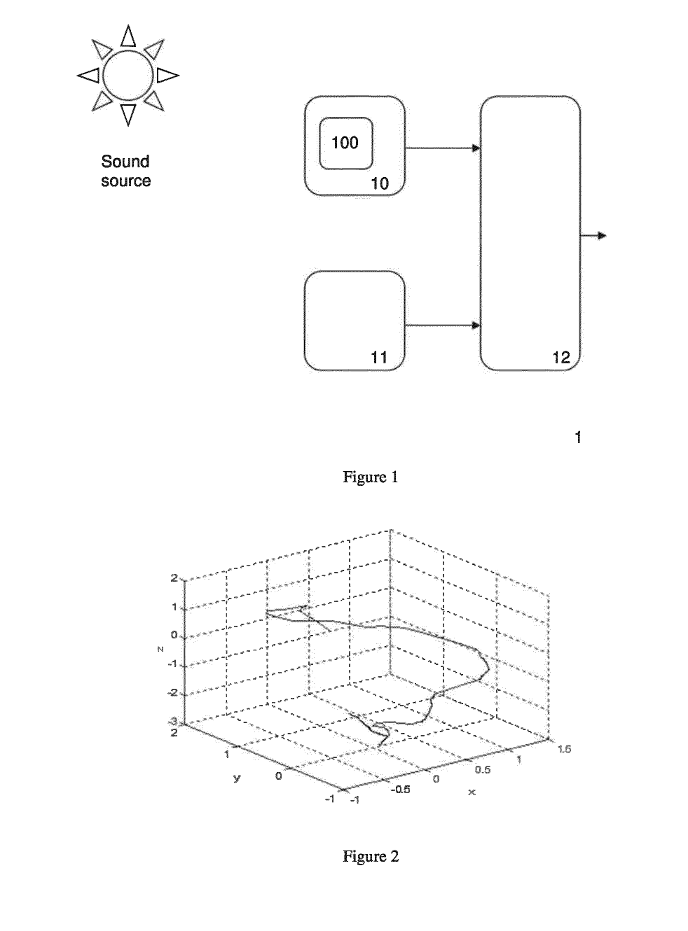

FIG. 1 is a block diagram of a system for localizing a sound source according to one embodiment of present invention. The system according to FIG. 1 is designated with 1 in its entirety. As shown in FIG. 1, the system 1 includes a movable unit 10, a motion tracking unit 11 and processing unit 12. The movable unit 10 may be integrated with a microphone 100. The movable unit 10 is movable with freedom with respect to a sound source in a random path, for example in linear movement, in circular movement, in forward and backward movement, and so on. The motion tracking unit 11 is adapted for tracking the movement of the movable unit 10. This allows the flexibility of the selection of the movable unit path set by the operator. FIG. 2 illustrates a random movement of the movable unit according to one embodiment of present invention. The microphone 100 is adapted for collecting the sound wave that transmits from the sound source and arrives at the microphone 100, and thus generating the microphone signal representing a value of a component of the collected sound wave. The motion tracking unit 11 is adapted for tracking a movement of the movable unit 10 and the microphone 100 integrated therewith where the sound wave is detected, and thus generating the motion tracking unit signal representing the position and velocity of the movable unit 10 and the microphone 100 integrated therewith. The movement can hereby be in the x, y, z direction as well as a rotation of the movable unit. The processing unit 12 is adapted for receiving the microphone signal of the microphone 100 of the movable unit 10 and motion tracking unit signal from the motion tracking unit 11 and obtaining information on a direction from which sound from the sound source arrives using the movable unit signal obtained during movement of the movable unit 10.

In the following, the functioning of the system 1 will be explained briefly. The processing unit 12 is capable of evaluating the microphone signal having been received or recorded or sampled with respect to the movement of the microphone 100 with the movement of the movable unit 10 from an initial position. Hence, the microphone signal includes the Doppler Effect frequency shift. By determining the Doppler effect frequency shift from the recorded signals collected by the same microphone during its movement, the relative direction of the movable unit to the sound source can be calculated and in combination with the position signals the location of the sound source can be determined. This would provide a simple system with lower costs and low volume for the sound source location. In addition, due to the integration of the microphone into the movable unit that can follow random path during its movement, the position for collecting the sound wave can be selected with less restriction. In addition, the accuracy of the motion tracking signal can be increased because the movable unit is not driven by devices that have tolerances, vibrations, or reflections at fixtures. Moreover, the motion tracking unit signal is expressive and good for indication of the movement of the microphone, and thus the accuracy of the position and velocity of the microphone arises.

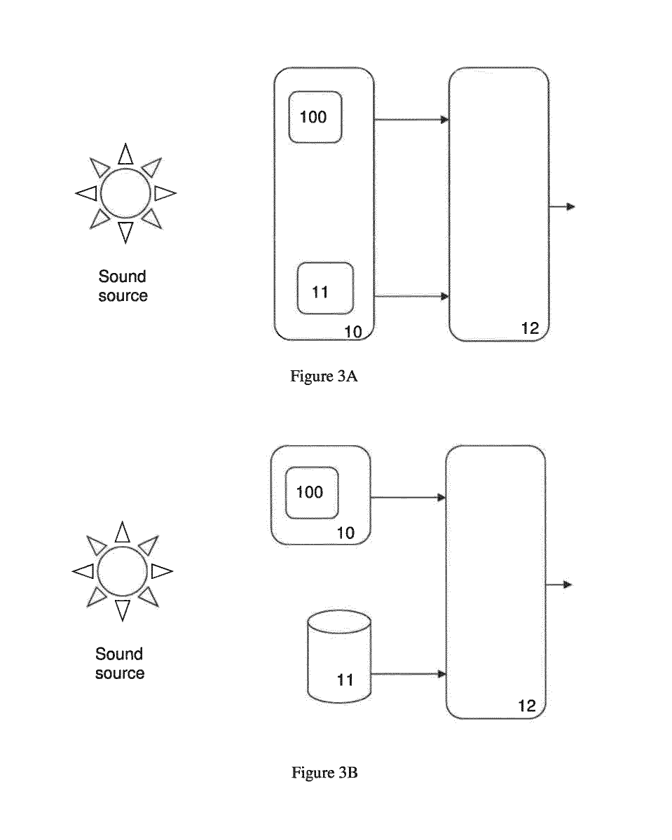

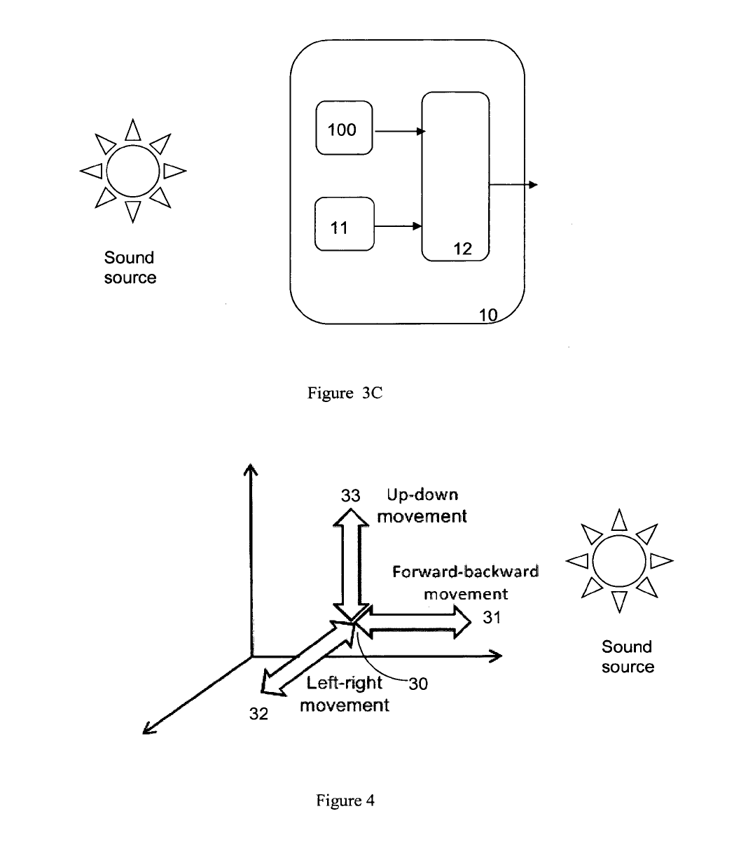

FIG. 3A is a block diagram of a system for localizing a sound source according to one embodiment of present invention. In this embodiment according to FIG. 3A, it is possible to integration of the motion tracking unit 11 into the movable unit 10, thus the motion tracking unit 11 is movable together with the movable unit 10. For example, the motion tracking unit 11 may be an IMU (inertial measurement unit) including gyroscope, and it may be integrated with the movable unit 10 together with the microphone 100. Thus, the movable unit 10 can simultaneously measure a combination of acoustic signal, at least one direction acceleration signals, at least one direction gyroscope signals. By having such configuration, the system 1 becomes more compact. FIG. 3B is a block diagram of a system for localizing a sound source according to one embodiment of present invention. In this embodiment according to FIG. 3B, the motion tracking unit 11 may be a vision tracking system which is separate from the movable unit 10 and generating the information about the velocity and position of the movable unit 10 by pattern recognition technology. FIG. 3C is a block diagram of a system for localizing a sound source according to one embodiment of present invention. The processing unit 12 may be integrated with the movable unit 10. Of course, the processing unit 12 may be separated from the movable unit 10 and may be implemented by a personal computer. The system may further include a screen being adapted for optical visualizing the position of the sound source for presenting as a map of sound locations, for example the location of sound sources is displayed on a picture of the scanned area. The screen may be integrated with the movable unit or on a personal computer.

In some embodiment, the processing unit 12 may be further adapted for determine direction information on evaluation of a level of the microphone signal during the movement of the microphone 100 and the movable unit 10. The processing unit 12 may, for example, determine a sound level of the microphone 100 with respect to a maximum and/or minimum amplitude while the movable unit 10 is moving with respect to the initial position, and further adapted for providing the information on the direction depending on the sound level of the microphone signal and the motion tracking unit signal. In summary, it thus can be stated that different information can be extracted from the microphone signal. For example, using the Doppler Effect frequency shift, an influence of the Doppler Effect on the microphone signal can be evaluated. An amplitude of the microphones signal may also be employed for improving the precision of the direction determination. However, the microphone signal may also include a combination of the above-mentioned information.

In some embodiment, all the measurements may be performed by mobile phone.

FIG. 4 shows a schematic illustration of typical movement of the movable unit according to one embodiment of present invention. As shown in FIG. 4, the movable unit 10 is at an initial position 30, where the acoustic signal should be recorded and microphone should not be moving. The stationary signal (assuming that the sound source is generating stationary signal) will be used as a reference in further analysis. The direction determination is based on the analysis of the non-stationary acoustic signal. Furthermore, to obtain such non-stationary signal it is required to perform movement of microphone while recording the acoustic signal. Such movement can be performed in 3 directions: forward-backward to the object of interest, left-right and up-down as it presented in FIG. 4 or a combination of the movement components in the 3 directions, it needs to be performed in front of the object of interest. As shown in FIG. 3, as example, the movable unit 10 may move to position 31 in the direction of forward-backward, to position 32 in the direction of left-right, to position 33 in the direction of up-down, or a position along the direction as a combination of the above three directions. Hence, a distance of the microphone 100 and the movable unit 10 from the sound source varies in the movement from the initial position 30 to position 31, 32, 33. The closer the microphone will stand to the sound source the better resolution of the measurements it is possible to achieve.

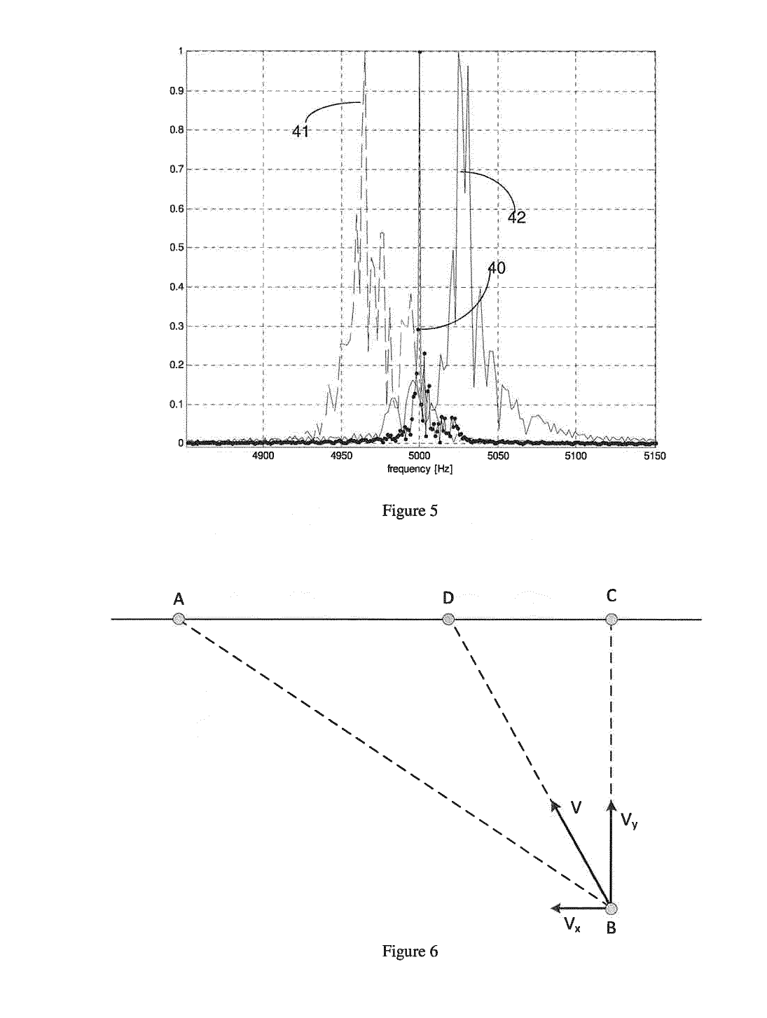

FIG. 5 shows a spectrum illustration of Doppler Effect frequency shift of the microphone signal provided by the microphone. For example, the sound source contains 5 kHz as a main frequency. At the initial position 30, the Doppler Effect frequency shift is minimum and/or even negligible. A first signal 40 is recorded, which means that the microphone 100 is not moving. A second signal 41 is recorded when the microphone 100 and the movable unit 10 are moving away from the sound source, while a third signal 42 is recorded when the microphone is getting closer to the sound source. As it is visible frequency peak at 5 kHz in case of the first signal 40 is relatively sharp which means that the frequency is constant in whole measurements period. It is possible to notice that second signal 41 is not a sharp peak any longer and it is clearly shifted to lower frequency while the third signal 42 is shifted into the higher frequency. The visible effect is known as a Doppler Effect. The above figure illustrating Doppler Effect proves that frequency shift is big enough to be measurable by the same microphone.

While performing acoustic measurements with moving microphone it is required to simultaneously measure 3 direction acceleration signals, 3 direction gyroscope. Typically, contemporary mobiles phones got those sensors embedded. These measurements will be utilized to detect mobile phone path and speed. Alternatively, vision markers might be utilized to obtain microphone movement path and velocity.

In the following, details regarding the procedure when determining the direction from which the sound from the sound source arrives at the microphone will be described here. Here, it is assumed that the frequency of the sound source is known, for example, 5 kHz. The direction of the sound source with respect to the microphone may, for example, be described by a direction of a velocity that deviates from the velocity of the microphone and the movable unit in terms of the measure of the angle between the two velocities. This description may apply to visualization of 2-dimension or 3-dimension source localization. For example, if the velocity of the movable unit is known, the direction of the sound source may also be described by the unknown angle, and this leads to the need for determination of the unknown angle which will be described hereinafter.

FIG. 6 shows a visualization of 2-dimension source localization according to one embodiment of present invention. Based on stationary measurements, the frequencies of interest should be selected. In this example our frequency of interest is 5 kHz. Then from the 2 direction speed path moment of time where speed is most constant should be selected. This speed we can marked as V. For the moment of time for which the speed V was selected in respective acoustic signal frequency shift of 5 kHz should be determined. Since such signal might be relatively short any methods like best fitting sinus should be better than standard FFT approach.

The Doppler Effect equation describe relation between speed of moving sound source or moving observer and frequency shift in acoustic signal recorded by observer. In presented case only the observer is moving. For this case the Doppler Effect equation looks as follows:

$${f}_{s} = {f}_{0} ( \frac{v \pm {v}_{0}}{v} ) \qquad ( 1 )$$

Where fₛ is frequency shift due to Doppler Effect, f₀ is actual sound source frequency, ν is sound speed which we can assume as equal to 340 m/s, ν₀ is the motion speed of the observer, in this case it is the speed of microphone. The sign of ν₀ depends on the direction of speed in relation to sound source.

For proper localization of sound source C, distance |CB| between object of interest C and microphone at initial position B is required. In the example presented in motion speed at point B is equal to V and as it is possible to notice the microphone is heading to point D which is moved the left side of sound source C by α angle. By rearranging the eq. (1) to the form where ν₀ will be on the left side of equation and assuming that microphone is getting closer to the sound source the equation got the following form:

$${v}_{0} = v ( 1 - \frac{{f}_{s}}{{f}_{0}} ) \qquad ( 2 )$$

If f₀ is the frequency of interest and fₛ is actual frequency shift of respective f₀ then ν₀ is microphone speed in relation to the sound source C. Therefore we can write:

V_{y}=ν₀ (3)

In FIG. 6 this component of speed was marked as Vy. The cosines of angle α can be expressed as

$$cos ( α ) = \frac{{V}_{y}}{V} \qquad ( 4 )$$

Substituting equation 3 in to eq 4 and use speed V obtain in previous it is possible to calculate angle α. By knowing the angle α it is possible to determine position of sound source as point C or point A as presented in FIG. 6.

Thus, it can, for example, be seen that in 2-dimension the sound source is in the direction along one of the two sides, BA and BC, of triangle BAC. Hence, based on the finding, a direction of the sound source can be determined. In summary, the processing unit 12 is adapted for evaluating a first Doppler Effect frequency shift of the first microphone signal with respect to a first directional movement of the movable unit from an initial position, and the processing unit 12 is adapted for providing the information on the direction depending on the first Doppler Effect frequency shift of the first microphone signal and the motion tracking unit signal.

In order to increase the accuracy of the determination of the sound source direction, the above procedure may be repeated for a different selection of velocity V at least once. By having such repetition, we may get another triangle B′A′C′ with at least one side overlapping one of the sides of BA and BC of triangle BAC. Hence, based on the finding involving a combination of the two triangles BAC and B′A′C′, the direction of the sound source can be determined in the direction from the intersection of the sides, for example BC and B′C′. In summary, the processing unit is further adapted for evaluating a second Doppler Effect frequency shift of a second microphone signal with respect to a second directional movement of the movable unit from the initial position and the processing unit is adapted for providing the information on the direction depending on the first Doppler Effect frequency shift and the second frequency shift of the first and second microphone signals and the motion tracking unit signals for the first and second directional movements of the movable unit.

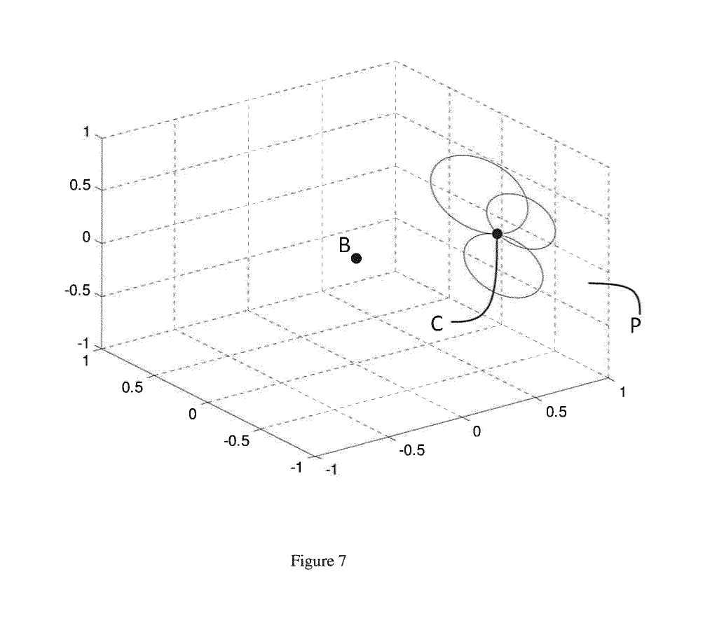

FIG. 7 shows a visualization of 3-dimension source localization according to one embodiment of present invention. A 3D plane P may be created in such a way so it is perpendicular to our initial motion point B and its centre is in point C which is our object of interest (in this case it is also our sound source). In case of localization sound source in 3D angle α calculated may create cone which is vertex is at the point B. Common part of cone and plane P is creating the ellipses which is marked on as FIG. 7. While repeating calculation three times three different cones will be calculated and 3 different ellipses will be drawn. Common part of ellipses is our sound source C which in this case is also object of interest. While substituting the plane P with real photo of object of interest sound source localization might be visualized as propose in FIG. 7. Hence, based on the finding, a direction of the sound source can be determined in 3-dimension. In summary, the processing unit is adapted for evaluating a first, second and third Doppler Effect frequency shift of a first, second and third microphone signal with respect to a first, second and third directional movement of the movable unit from the initial position; and the processing unit is adapted for providing the information on the direction depending on the first, second and third Doppler Effect frequency shifts of the first, second and third microphone signals and the motion tracking unit signals for the first, second and third directional movements of the movable unit.

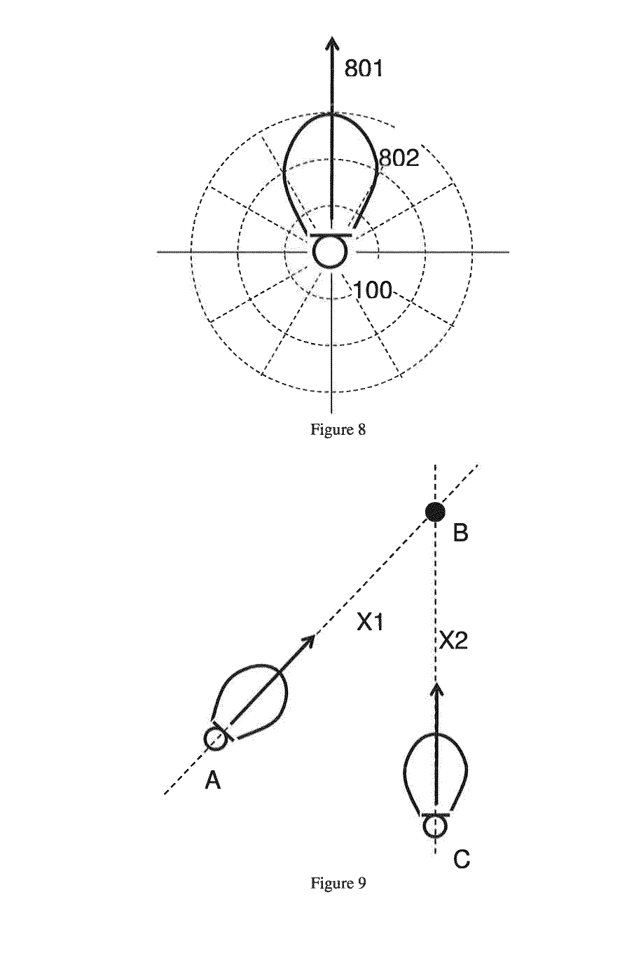

Alternatively the sound amplitude could be also evaluated from the recorded sound signals for determining the sound source location. The sound sensitivity of a microphone varies with the direction of the sound source and FIG. 8 shows a typical directional sensitivity of a microphone according to one embodiment of present invention. The trajectory 802 shows the sensitivity of the microphone 100 for sound arriving under different angles. In the direction indicated by the arrow 801 the microphone 100 will reach its maximum sensitivity and thus the highest output level. By turning the movable unit 10 and thus the microphone 100 in such a way that the maximum and/or minimum output level is reached, the microphone unit will direct in the direction of the sound source and this direction can be determined.

Alternative also other sound amplitudes as e.g. the minimum sound level could be used for a direction detection. The level and the direction must only be clearly determinable. The shown sensitivity is a typical sensitivity of a microphone and will vary with the exact embodiment of the microphone and its environment. But the maximum sensitivity will only be achieved in certain direction and can be used for determining the direction of a sound source.

FIG. 9 shows the determination of a sound source location is according to the embodiment of FIG. 8. At a known position A the microphone is turned in the direction X1 of its maximum and/or minimum amplitude and will thus direct to the location of the sound source B. At second known position C, which is not in line of the direction determined at position A, again the microphone is turned to its maximum and/or minimum amplitude and will give a second direction X2 measurement of the sound source location B. The intersection point of the two direction lines X1 and X2 will give the location of the sound source. The positions A and C are hereby determined with the motion tracking unit 11. The motion tracking can be one of the already above described methods or any other method for determining the positions A and C. Alternatively the motion tracking unit could also consist of two marked positions in the space, where the two measurements are performed.

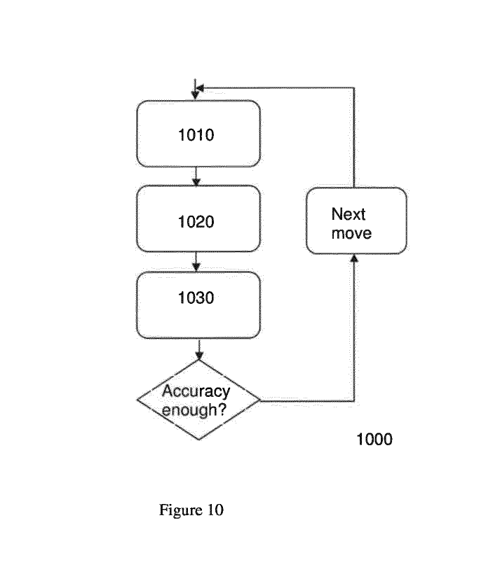

FIG. 10 shows a flowchart of a method for localizing a sound source according to one embodiment of present invention. The method 1000 includes, in step 1010, obtaining microphone signal and motion tracking unit signal from a movable unit integrated with a microphone and a motion tracking unit during free movement of the movable unit. It is determined a sampling rate at which microphone signal is sampled, based on a known frequency of the sound signal. For example, a sampled version of the microphone signal from the microphone 100 is present, which was generated by sampling the microphone signal at a sampling frequency at least twice bigger than the frequency of interest.

The method 1000 further includes, in a step 1020, determining a velocity and an initial position of the movable unit and the microphone on the basis of motion tracking unit signal, and determining a Doppler Effect frequency shift on the basis of the microphone signal.

The method 1000 further includes, in a step 1030, determining a direction of the microphone with respect to the sound source, based on an value of a Doppler Effect frequency shift and the motion tracking unit signal. For example, a Doppler Effect frequency shift among the microphone signals is dependent on the speed of the microphones with respect to the sound source. The offset of the Doppler Effect frequency shift indicates how great a speed of the movable unit is moving with respect to the sound source. For example, evaluation of the direction of the sound source may be performed according to the algorithm described according to FIGS. 6 and 7.

Alternatively, the method 1000 further includes, in a step 1010, evaluating a sound level of the microphone signal with respect to a maximum and/or minimum amplitude while the movable unit is moving with respect to the initial position, and in step 1030, providing the information on the direction depending on the sound level of the microphone signal and the motion tracking unit signal.

With different levels of the accuracy of the direction of the sound source to be determined, the procedure may be performed at least once, itinerantly for a first Doppler Effect frequency shift of the first microphone signal with respect to a first directional movement of the movable unit from an initial position, a second Doppler Effect frequency shift of the second microphone signal with respect to a second directional movement of the movable unit from an initial position, and a third Doppler Effect frequency shift of the third microphone signal with respect to a third directional movement of the movable unit from an initial position, and the motion tracking unit signals respectively for the first, second and third directional movement of the movable unit. Alternatively, the procedure may take into consideration of a sound level of the microphone signal with respect to a maximum and/or minimum amplitude while the movable unit is moving from the initial position, and the motion tracking unit signal for the directional movement of the movable unit.

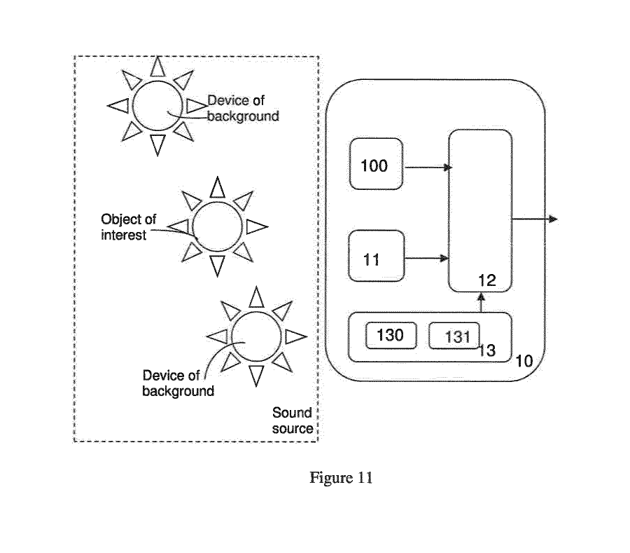

FIG. 11 is a block diagram of a system for separating sound from an object of interest and that from its background by using said system for localizing sound source as described above according to FIG. 3C. The skilled person should understand that the sound source localizing system can be those described according to any of FIGS. 1 to 10 or a static unit including a multiple of microphones by using acoustic holography or beamforming technique. The sound source direction can also be determined with a static unit, where e.g. two or more microphones are located at certain separated positions. Due to the different travel paths from the sound source to the different microphones, the sound will arrive with a certain time delay. This time delay will result in a phase shift of the signals determined by the different microphone and by evaluating this phase shift, the direction of sound can be determined. As shown in FIG. 11, an object of interest and many devices of its background consist of the sound source. The sound separating system 11 includes the sound source localizing system 1 with a microphone 100, and an object direction reference determination part 13. The object direction reference determination part 13 is for determining, as object direction reference, information on directions of said object of interest with respect to said sound source localizing system 1.

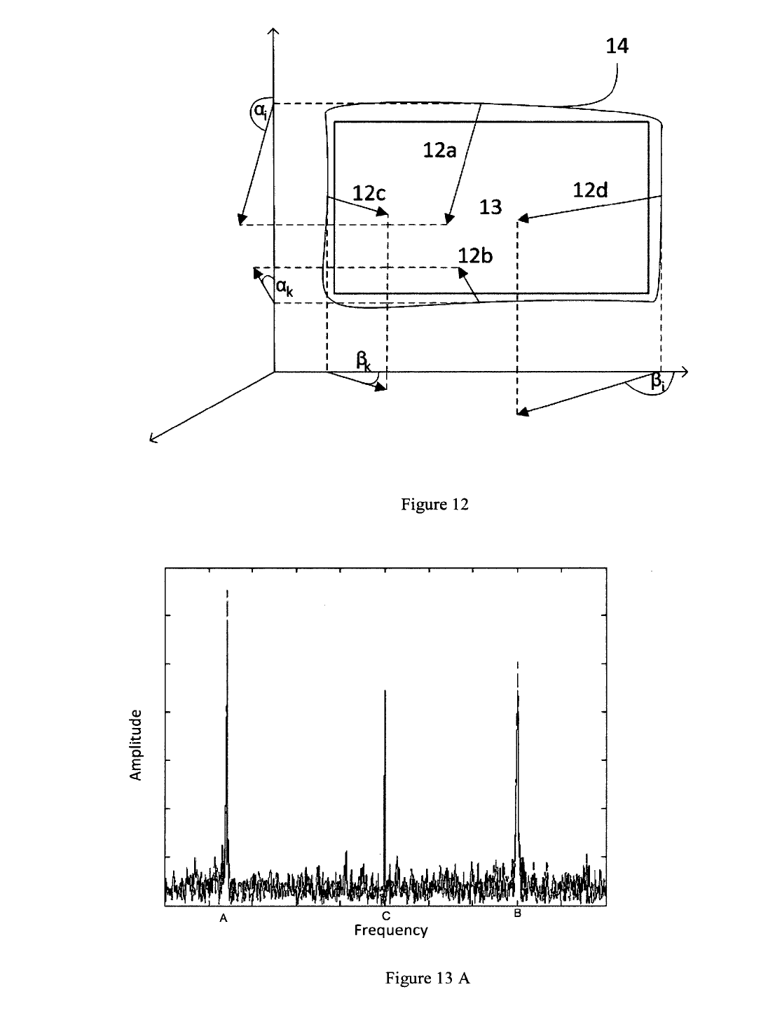

FIG. 12 shows the illustration of the direction indicated by the object direction reference. As shown in FIG. 12, the object direction reference may indicate a multiple of directions as shown by the arrows, in which the sound may arrive at the sound source localizing system 1 from different contour 14 points of the object of interest 15, for example, the direction 12a starting from the upper contour 14 of the object of interest 15, the direction 12b starting from the lower contour 14 of the object of interest 15, the direction 12c starting from the left contour 14 of the object of interest 15, the direction 12d starting from the right contour 14 of the object of interest 15, and etc. Based on the information on the object direction reference, the processing unit 12 of the sound source localizing system 1 can locate the object of interest with respect to the position of itself. The more points on the contour 14 of the object of interest are considered, the more accurate the location with respect to the sound source localizing system 1 can be determined. As alternative, the skilled person shall understand that other technology for determination of objection direction reference is applicable, for example select the directions from the points inside the contour 14 of the object of interest.

Back to FIG. 11, the processing unit 12 of the sound source localizing system 1 can obtain information on a direction from which sound arrived at said sound source localizing part 1 from the sound source by using microphone signal, which has been described above by the embodiments according to FIGS. 1 to 10. To avoid redundancy, detailed description thereabout is omitted hereafter. The processing unit 12 further can compare the information with the object direction reference so as to separate the sound from the background of said sound source. For example, the processing unit 12 can judge if said direction from which the sound arrived at the sound source localizing system 1 falls under the scope of the object direction reference so as to filter the sound the background, namely the remained sound after the filtering mainly contain those arrived from the object of interest. Direction of sound can be described by two angles α in vertical plane and P in horizontal plane (see FIG. 12). To separate sound which origin in object of interest from sound of its background angles of sound direction with angles of reference direction needs to be compare. If sound of interest got respective angles of direction \tilde{α} and \tilde{β} to following comparison of angles needs to be perform:

$$\{ \begin{matrix}\tilde{α} < {α}_{i} \\ \tilde{α} > {α}_{k}\end{matrix} , and \{ \begin{matrix}\tilde{β} < {β}_{i} \\ \tilde{β} > {β}_{k}\end{matrix} , \qquad ( 5 )$$

where αᵢ is an angle in vertical plane of reference direction, βᵢ is an angle in horizontal plane of the same reference direction, αₖ is an angle in vertical plane of reference direction which is located on opposite site of contour to the respective direction described by angles αᵢ and βᵢ, βₖ is an angle in horizontal plane of reference direction which is located on opposite site of contour to the respective direction described by angles αᵢ and βᵢ, If formula (5) is true then sound described by direction angles \tilde{α} and \tilde{β} is coming from within the contour which means its origin is in object of interest. Contour 14 can be 2 dimensional line creating two dimensional plane and the angles of directions can be mapped into this 2 dimensional plane as well indicating location of sound in 2 dimensional space.

By having the sound separating system, it can extract the background noise from a specific device respective location and analyse only these signals from the object of interest.

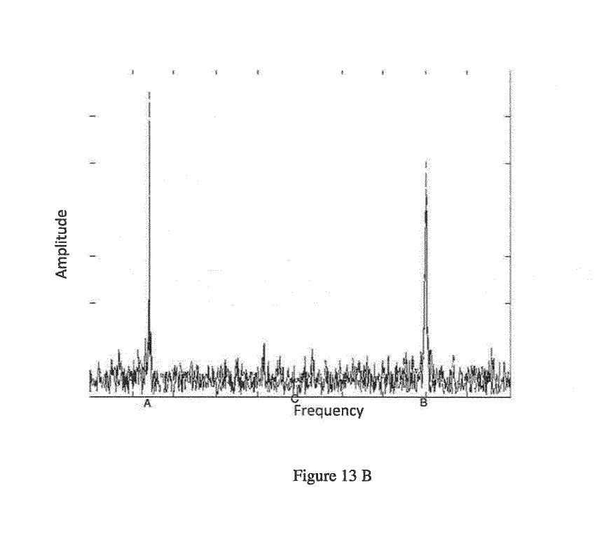

FIGS. 13A and 13B show the acoustic spectrum before and after the filtration according to an embodiment of present invention. As comparison of FIGS. 13A and 13B, there is difference of the sound component amplitude in terms of frequency. For example, the amplitude for sound component at frequency A or B in FIG. 13A is of the same height with that of FIG. 13B, which means all the sound with frequency A or B arrived at the sound source localizing system 1 from the object of interest; the amplitude for sound component at frequency C in FIG. 13A has value but its counterpart in FIG. 13B is zero, which means all the sound with frequency C arrived at the sound source localizing system 1 from the background. By having such comparison of sound directions performed by the processing unit 12, the sound separating system 11 is able to automatically separate the sound from the object of interest and its background. The sound source localizing system can detect only acoustic signals from the direction of the object of interest, while signals from other locations as of the background are suppressed. Therefore, the influence of the sound from the background with that from the object of interest is removed, and this is particular helpful in case that the former frequency is stronger than the latter frequency and the characteristic of the sound from the object of interest is unknown.

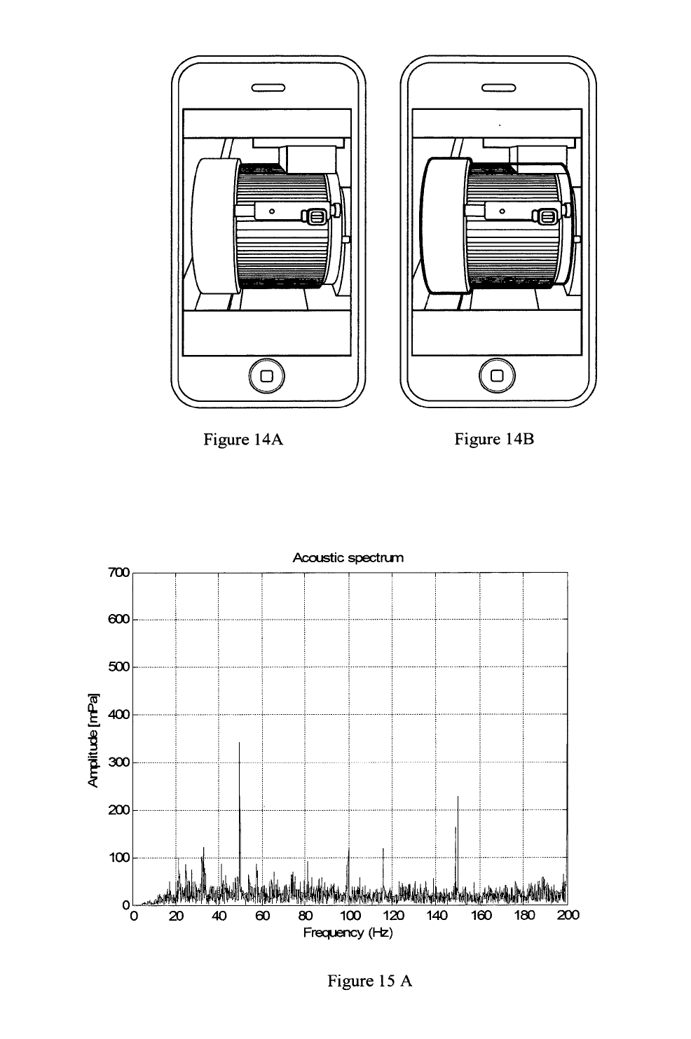

Back to FIG. 11, the object direction reference determination part 13 may include a camera 130 and a human machine interface 131. The camera 130 can capture picture of the object of interest and its background, and the human machine interface 131 can obtain the information on the contour of said object of interest as regards its background based on the picture captured by the camera 130. By having the human machine interface, the user can select the object direction reference to be analysed. The skilled person should understand that the human machine interface 131 can be implemented by a touch screen, a personal computer, and etc. The camera 130 can be directed to the area of sound source including the object of interest and its background, which is monitored by the sound separating system 11 and this area is displayed on the screen. The user can then select the object of interest to be investigated by marking it on the screen. This can be done by either clicking onto the position, drawing a line around the object or any other input method. FIGS. 14A and 14B show pictures taken by the camera and reproduced on the human machine interface before and after marking the contour of the object of interest according to an embodiment of present invention. As shown in FIGS. 14A and 14B, an electrical motor is an example of the object of interest and a touch screen serves an example of the human machine interface 131. As illustrated by FIG. 14B, the user marked the contour of the electrical motor by drawing its contour on the touch screen. The object orientation determination part 13 can determine the object direction reference based on the information on the contour of the electrical motor as regards its background. If the location is determined to be inside the contour of the electrical motor as indicated by portion in the FIG. 14B, the specific frequency component should remain in in FIG. 13B. If the location is in the area outside of the contour of the electrical motor, the specific frequency component will be removed from the spectrum in FIG. 13A and not reproduce in the spectrum in FIG. 13B. This operation will be done for all frequency visible in the spectrum or for a defined frequency range or noise pattern.

Besides, the localizing system 1 can be used for a condition monitoring system, where the processing unit 12 can be further adapted for judging a condition of said object of interest based on a frequency of said separated sound. Again taking the electrical motor as an example of the object of interest, the acoustic spectrum from FIG. 13B can be considered as relative similar to the vibration spectrum of the electrical motor. Therefore similar methods as for vibration analysis can be applied. For example, it is well known that in case of electric motors static eccentricity cause additional forces visible in vibration at frequency f_{ecc} given by following equation:

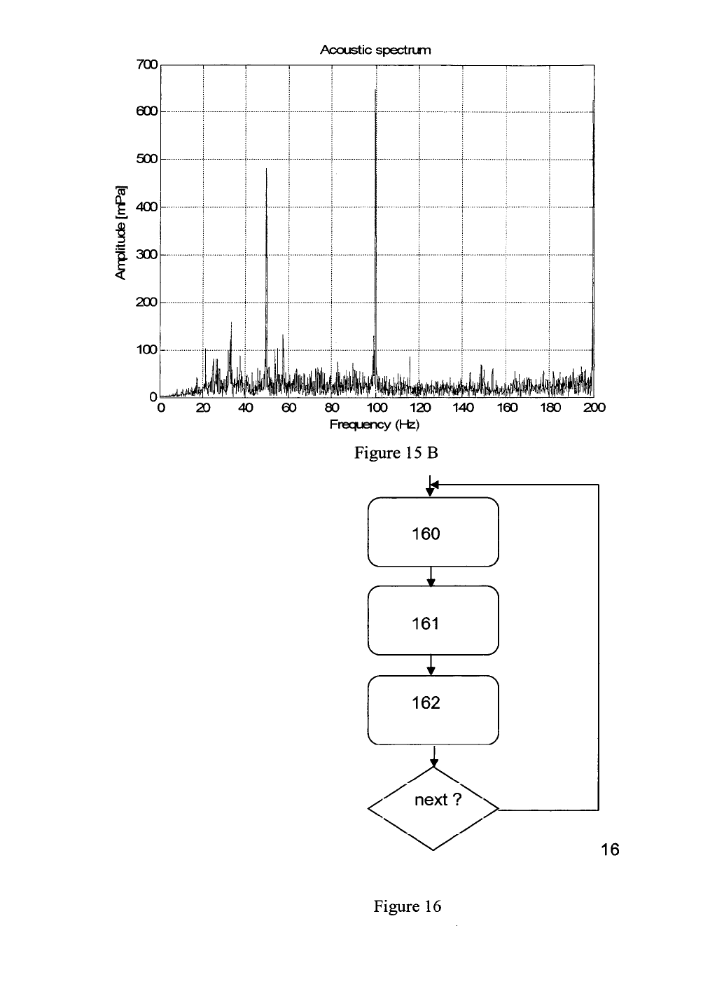

f_{ecc}=2fₗᵢₙₑ (6)

where fₗᵢₙₑ is power supply frequency. FIGS. 15A and 15B present example spectrum of two electrical motor cases. FIG. 15A presents acoustic spectrum of healthy motor case while FIG. 15B presents acoustic spectrum electrical motor with static eccentricity. In below case, both electrical motors were supplied by 50 Hz, therefore static eccentricity related frequency f_{ecc} should be visible at 100 Hz. It is possible to notice that FIG. 15B consist of high peak at around 100 Hz while FIG. 15A did not. Value of this peak is above 600 mPa, while on the FIG. 15A this peak is smaller than 350 mPa. By taking the amplitude of f_{ecc} frequency as static eccentricity indicator it is clearly visible that the electrical motor in case of FIG. 15B got higher level of static eccentricity than healthy electrical motor from case of FIG. 15A. Those results are very similar to vibration based results and they are clearly indicating static eccentricity. However if those acoustic measurements will be taken by normal microphone there will be no guarantee that source of frequency of interest (in our case f_{ecc}) is electrical motor body. Since in this embodiment all the remaining frequencies visible in spectrum after filtration are having its source within the contour (electrical motor body), it is understandable that this frequency is not cause by background noise. By having the condition monitoring system, the extracted signals are processed automatically for failure detection. The condition monitoring system may further include an alarm device, for example by a loudspeaker, for the user to do a manual failure analysis.

It is understandable to the skilled person that the components of the sound source localizing system 1 can be implemented in a mobile phone as an extension of its functionality.

FIG. 16 shows flowchart of a method for separating sound from an object of interest and that from its background according to an embodiment of present invention. The method 16 includes, in step 160, determining, as object direction reference, information on directions of the object of interest with respect to a sound source localizing part, in step 161, obtaining information on a direction from which sound arrives at the sound source localizing part from the sound source by using microphone signal, and in step 162, comparing said obtained information with the object direction reference so as to separate the sound from said background of said sound source. The method 16 may further include predetermining said object direction reference based on the information on contour of said object of interest as regards its background. The method 16 may be used for condition monitoring, and thus it may further include judging a condition of said object of interest based on a frequency of said filtered sound. It is possible to iteratively check the direction of each single frequency from the acoustic spectrum to be inside the contour or not.

The method 16 may be supplemented by all those steps and features described herein. For example, obtaining 161 information on a direction from which sound arrives at the sound source localizing part may include one or more of the method according to FIG. 10.

Though the present invention has been described on the basis of some preferred embodiments, those skilled in the art should appreciate that those embodiments should by no way limit the scope of the present invention. Without departing from the spirit and concept of the present invention, any variations and modifications to the embodiments should be within the apprehension of those with ordinary knowledge and skills in the art, and therefore fall in the scope of the present invention which is defined by the accompanied claims.

1-20. (canceled)

21. A system for separating sound from an object of interest and that from its background, a sound source consists of the object of interest and its background, including:
a sound source localizing part, including at least one microphone and a processing unit;
an object direction reference determination part, being adapted for determining, as object direction reference, information on directions of said object of interest with respect to said sound source localizing part;
wherein:
said sound source localizing part includes:
a movable unit, being adapted for free movement and being integrated with said microphone; and
a motion tracking unit, being adapted for tracking the movement of the movable unit;
said processing unit is adapted for receiving said microphone signal and motion tracking unit signal and obtaining information on a direction from which sound arrives at said sound source localizing part from said sound source by using the microphone signal and motion tracking unit signal obtained during movement of the movable unit, and comparing it with said object direction reference so as to separate the sound from the object of interest and its background.

22. The system according to claim 21, wherein said processing unit is further adapted for judging if said direction from which said sound arrived at said sound source localizing part falls under the scope of said object direction reference so as to filter the sound from the background of said sound source.

23. The system according to claim 21, wherein the movable unit is integrated with the motion tracking unit.

24. The system according to claim 21, wherein the motion tracking unit is an inertia measurement unit.

25. The system according to claim 23, wherein the motion tracking unit is an inertia measurement unit.

26. The system according to claim 21, wherein the motion tracking unit is a vision tracking system.

27. The system according to claim 23, wherein the motion tracking unit is a vision tracking system.

28. The system according to claim 21, wherein said processing unit is further adapted for evaluating Doppler Effect frequency shift of the microphone signal with respect to a directional movement of the movable unit from an initial position.

29. The system according to claim 24, wherein said processing unit is further adapted for evaluating Doppler Effect frequency shift of the microphone signal with respect to a directional movement of the movable unit from an initial position.

30. The system according to claim 26, wherein said processing unit is further adapted for evaluating Doppler Effect frequency shift of the microphone signal with respect to a directional movement of the movable unit from an initial position.

31. The system according to claim 21, wherein said processing unit is further adapted for evaluating a sound level of the microphone signal with respect to a maximum and/or minimum amplitude while the movable unit is moving with respect to the initial position.

32. The system according to claim 24, wherein said processing unit is further adapted for evaluating a sound level of the microphone signal with respect to a maximum and/or minimum amplitude while the movable unit is moving with respect to the initial position.

33. The system according to claim 28, wherein the processing unit is further adapted for providing the information on the direction depending on the Doppler Effect frequency shift of the microphone signal and the motion tracking unit signal.

34. The system according to claim 31, wherein the processing unit is further adapted for providing the information on the direction depending on the Doppler Effect frequency shift of the microphone signal and the motion tracking unit signal.

35. The system according to claim 31, wherein the processing unit is further adapted for providing the information on the direction depending on the sound level of the microphone signal and the motion tracking unit signal.

36. The system according to claim 33, wherein the processing unit is further adapted for providing the information on the direction depending on the sound level of the microphone signal and the motion tracking unit signal.

37. The system according to claim 21, wherein said sound source localizing part is an acoustic camera, including a plurality of microphones.

38. The system according to claim 21, wherein said object direction reference determination part includes:
a camera, being adapted for capturing picture of said object of interest and its background; and
a human machine interface, being adapted for obtaining information on contour of said object of interest as regards its background based on said picture;
wherein:
said object direction reference determination part is further adapted for predetermining said object direction reference based on the information on said contour of said object of interest as regards its background.

39. The system according to claim 21, wherein said processing unit is further adapted for judging a condition of said object of interest based on a frequency of said separated sound.

40. The system according to claim 22, further including an alarm device, being adapted for generating alarm in response to failure condition of said object of interest.

41. A mobile phone, including the system of claim 21.
